(19) United States
(12) Patent Application Publication
(10) Pub. No.: US 2012/0327062 A1
(43) Pub. Date: Dec. 27, 2012

(54) ELECTRONIC APPARATUS, CONTROL METHOD OF ELECTRONIC APPARATUS, AND NON-TRANSITORY COMPUTER-READABLE MEDIUM STORING COMPUTER EXECUTABLE CONTROL PROGRAM OF ELECTRONIC APPARATUS

(76) Inventor: Masaya Endo, Higashiyamato-shi (JP)

(21) Appl. No.: 13/440,271

(22) Filed: Apr. 5, 2012

(30) Foreign Application Priority Data
Jun. 27, 2011 (JP) 2011-142212

(51) Int. Cl. G06F 3/038

(52) U.S. Cl. 345/212

(57) ABSTRACT

According to one embodiment, an electronic apparatus includes: a storage module which stores display information of a work screen that is displayed on an image display module according to an instruction to switch to a standby state; a power supply module which receives a resume instruction in the standby state, and which supplies power to the image display module according to the resume instruction; and a work screen display module which displays an image on the power-supplied image display module using display information of the work screen stored in the storage module.

### CROSS REFERENCE TO RELATED APPLICATION(S)

The application is based upon and claims the benefit of priority from Japanese Patent Application No. 2011-142212 filed on Jun. 27, 2011; the entire contents of which are incorporated herein by reference.

### FIELD

Embodiments described herein relate generally to an electronic apparatus, a control method of the electronic apparatus, and a non-transitory computer-readable medium storing a computer executable control program of the electronic apparatus.

### BACKGROUND

Recently, suppressing an amount of power consumed in an electronic apparatus has become an issue. For example, when temporarily halting the use of the electronic apparatus, there is a technology of controlling the power consumption by switching the electronic apparatus to a suspend state.

However, when the electronic apparatus in the suspend state is resumed and then returned to an active state, a certain time is generally required. Therefore, the certain time required when the electronic apparatus is returned from the suspend state to the active state is an inconvenient for a user.

Accordingly, an issue having been challenged in the related art is to decrease the time required when the electronic apparatus is returned to the active state after being resumed.

### BRIEF DESCRIPTION OF THE DRAWINGS

Exemplary embodiments of the present invention will be described in detail based on the following figures, wherein:

FIG. 1 is a diagram illustrating an example of an appearance of an electronic apparatus according to an embodiment;

FIG. 2 is a diagram illustrating a state in which a storage module (e.g., static screen buffer (SSB)) and a power supply module to supply electric power to a liquid crystal display (LCD) are being installed substantially in an image display module in the electronic apparatus according to the embodiment;

FIG. 3 is a block diagram illustrating a configuration of the electronic apparatus according to the embodiment;

FIG. 4 is a block diagram illustrating the configuration of the electronic apparatus according to the embodiment;

FIG. 5 is a diagram for explaining a power saving standard used in the electronic apparatus according to the embodiment;

FIG. 6 is a diagram illustrating a work screen displayed when changing to a standby state (S3) in the electronic apparatus according to the embodiment;

FIG. 7 is a flowchart illustrating a process of storing display information of a work screen that is displayed on an image display module, according to an instruction to switch to a standby state, in the electronic apparatus according to the embodiment;

FIG. 8 is a flowchart illustrating a process of displaying the display information using the stored display information of work screen according to a resume instruction received in a standby state, in the electronic apparatus according to the embodiment;

FIG. 9 is a view illustrating a log-in screen displayed in the electronic apparatus according to the embodiment;

FIG. 10 is a flowchart illustrating a process of storing the displayed information of a log-in screen, according to an instruction to switch to a standby state, in the electronic apparatus according to the embodiment; and

FIG. 11 is a flowchart to describe the process of displaying the display information using the stored display information of the work screen, according to a resume instruction received in a standby state, in the electronic apparatus according to the embodiment.

### DETAILED DESCRIPTION OF THE EXEMPLARY EMBODIMENTS

According to one embodiment, an electronic apparatus includes: a storage module which stores display information of a work screen that is displayed on an image display module according to an instruction to switch to a standby state; a power supply module which receives a resume instruction in the standby state, and which supplies power to the image display module according to the resume instruction; and a work screen display module which displays an image on the power-supplied image display module using display information of the work screen stored in the storage module.

Hereinafter, embodiments will be described with reference to the accompanying drawings.

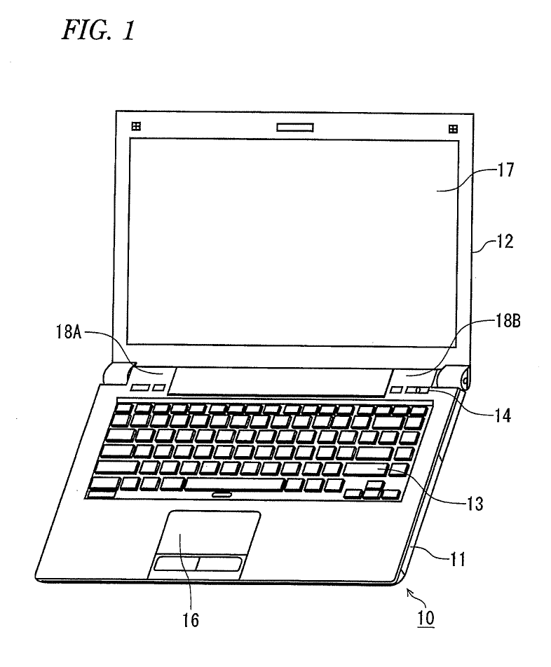

FIG. 1 is a diagram illustrating an exemplary appearance of an electronic apparatus according to an embodiment.

The electronic apparatus is embodied as, for example, a notebook type personal computer (notebook PC or PC) 10.

The embodiment is not limited to the personal computer, and thus, is applicable to other type of electronic apparatuses such as a television (TV), a mobile phone and a portable electronic apparatus.

As shown in FIG. 1, the electronic apparatus (notebook PC) 10 includes a computer (notebook PC) body 11 and an image display module 12. For example, a liquid crystal display (LCD) 17 is inserted in the image display module 12.

The image display module 12 is attached to the PC body 11 to be rotatable between an opening position for exposing a top face of the PC body 11 and a closing position for covering the top face of the PC body 11.

The PC body 11 has a thin box-typed case. Various components such as a keyboard 13, a power button 14 to turn ON/OFF the PC 10, a touch pad 16 and speakers 18A and 18B are provided on the top face of the PC body 11.

A universal serial bus (USB) cable of a USB 2.0 standard or a USB connector 19 (not shown) for connecting a USB device is installed on, for example, a right side face of the PC body 11.

An external display connection terminal (not shown) compatible with, for example, a high-definition multimedia interface (HDMI) standard is installed on a rear face of the PC body 11. The external display connection terminal is used to output a digital image signal to an external display.

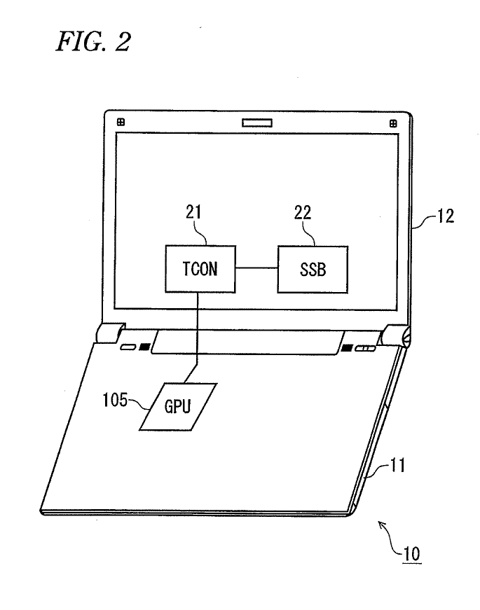

FIG. 2 is a diagram illustrating a state in which a storage module (SSB) and a power supply module to supply the electric power to a liquid crystal display (LCD) are being installed substantially in the image display module 12 in the electronic apparatus 10 according to the embodiment.

The reference numeral 21 represents, for example, a timing controller (TCON) that controls displaying of a LCD 17 inserted into the image display module 12. The reference numeral 22 represents a static screen buffer (SSB).

As described below, in the embodiment, a system memory 103 included in the PC body 11 is referred to as a first storage module for convenience. Thus, the SSB 22 is referred to as a second storage module.

The timing controller (TCON) 21 is controlled by a graphics processing unit (GPU) 105.

In the embodiment, as shown in FIG. 2, the TCON 21 and the SSB 22 are installed within the image display module 12, that is, substantially in the image display module 12.

Hereinafter, the SSB 22 will be described.

The static screen buffer (SSB) 22 is a memory defined as Embedded DisplayPort (eDP) version 1.3 which is announced by, for example, Video Electronics Standards Association (VESA).

The SSB 22 is constituted by, for example, dynamic random access memory (DRAMs). Also, since the power is continuously supplied from, for example, a backup source (described later) even though the electronic apparatus 10 is in a standby state, it is possible to maintain data of, for example, displayed information of the image display module 12.

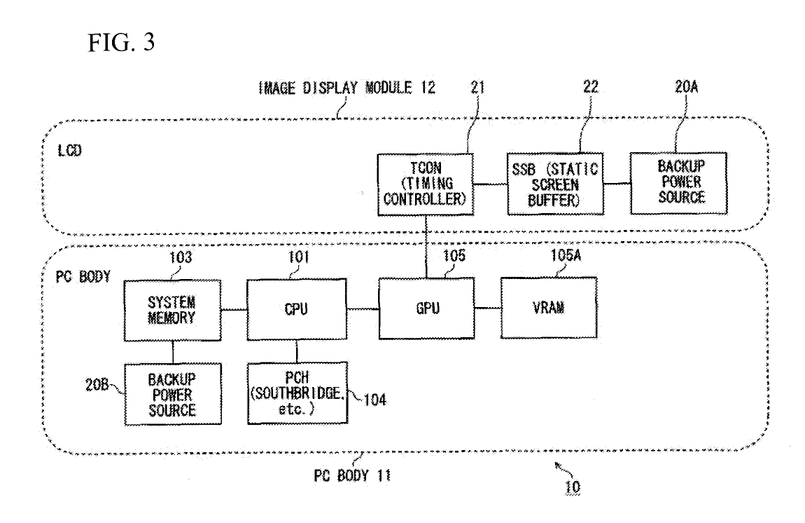

FIG. 3 is a block diagram illustrating the configuration of the electronic apparatus 10 according to the embodiment.

As described above, the image display module 12 includes the TCON 21 and the SSB 22.

As shown in FIG. 3, the SSB 22 is connected to a backup power source 20A. When the electronic apparatus 10 is in the standby state, the SSB 22 is supplied with electric power from the backup power source 20A. Accordingly, for example, even when the electronic apparatus 10 is switched to the standby state, it is possible to maintain data of display information such as the information displayed on the image display module 12 in the SSB 22.

The PC body 11 includes the system memory 103, a central processing unit (CPU) 101, the GPU 105, a video random access memory (VRAM) 105A, a backup power 20B, and a platform controllable herb (PCH) 14 which includes a southbridge or the like.

As described above, the system memory 103 is connected to the backup power source 20B. The same power source as described above (e.g., backup power source 20A) or a separate power source may be utilized for the backup power source 20B.

When the PC 10 is in the standby state, the system memory 103 is supplied with the power from the backup power source 20B. For example, when the PC 10 is switched to the standby state, it is possible to maintain data of, for example, an operating system (OS) for driving the PC 10.

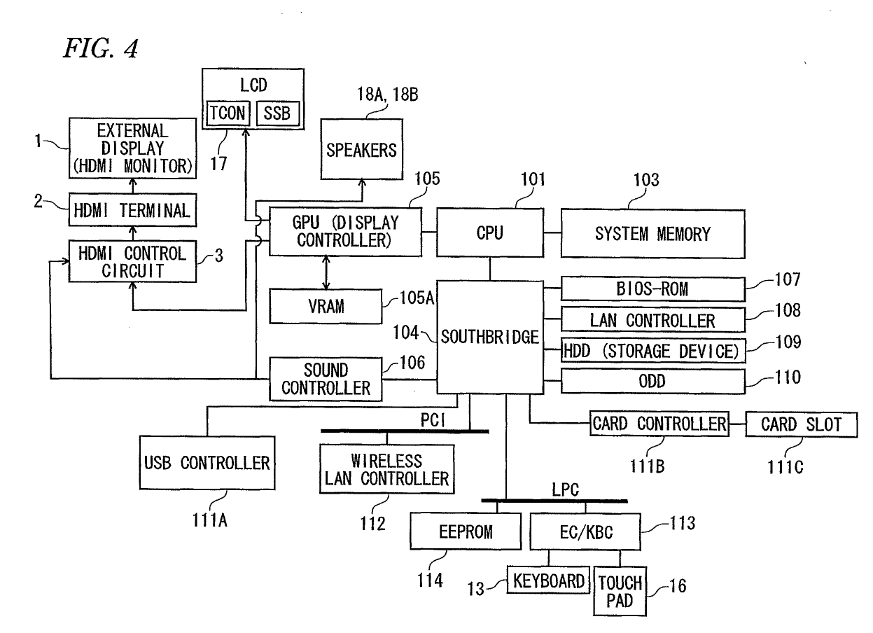

FIG. 4 is a block diagram illustrating the configuration of the electronic apparatus 10 according to the embodiment.

As shown in FIG. 4, the PC 10 includes various components such as the CPU 101, the system memory 103, the southbridge 104, the GPU 105, the VRAM 105A, a sound controller 106, a basic input/output system-read only memory (BIOS-ROM) 107, a local area network (LAN) controller 108, a hard disk drive (HDD) (memory device) 109, an optical disk drive (ODD) 110, a USB controller 111A, a card controller 111B, a card slot 111C, a wireless LAN controller 112, an embedded controller/keyboard controller (EC/KBC) 113, and an electrically erasable programmable ROM (EEPROM) 114.

The CPU 101 is a processor that controls the operation of each unit or module within the PC 10.

The CPU 101 executes a basic input/output system (BIOS) stored in the BIOS-ROM 107. The BIOS is a program for hardware control. A memory controller is built in the CPU 101 as well controlling the access of the system memory 103. Also, the CPU 101 has a function of executing a communication with the GPU 105 through, for example, a serial bus of a PCI EXPRESS standard.

The GPU 105 is a display controller to control the LCD 17 used as a display monitor of the PC 10.

A display signal generated by the GPU 105 is transmitted to the LCD 17. The GPU 105 may transmit a digital image signal to an external display 1 via an HDMI control circuit 3 and an HDMI terminal 2.

The HDMI terminal 2 is an external display connection terminal as described above transmitting uncompressed digital image signal and digital audio signal to the external display 1 such as a TV using a single-line cable. The HDMI control circuit 3 is an interface for transmitting a digital image signal to the external display 1 called an HDMI monitor via the HDMI terminal 2.

The southbridge 104 controls each device on a peripheral component interconnect (PCI) bus and each device on a low pin count (LPC) bus. The southbridge 104 is embedded with an integrated drive electronic (IDE) controller for controlling the HDD 109 and the ODD 110.

The southbridge 104 has a function of executing a communication with the sound controller 106.

The sound controller 106 is a sound source device and outputs audio data to be played, to the speakers 18A and 18B or the HDMI control circuit 3. The LAN controller 108 is a wired communication device that executes a wired communication of, for example, an Institute of Electrical and Electronics Engineers (IEEE) 802.3 standard. Meanwhile, the wireless LAN controller 112 is a wireless communication device that executes a wireless communication of, for example, an IEEE 802.11g standard. The USB controller 111A executes a communication with an external device compatible with, for example, a USB 2.0 standard.

For example, the USB controller 111A is used to receive image data file stored in a digital camera. The card controller 111B executes recording and reading-out of data with respect to a memory card such as a secure digital (SD) card that is inserted into a card slot installed in the PC body 11.

The EC/KBC 113 is a single-chip micro computer in which an embedded controller for power management and a keyboard controller for controlling the keyboard 13 and the touch pad 16, are integrated. The EC/KBC 113 has a function of turning ON/OFF the PC 10 according to an operation of the power button 14 by the user.

In the embodiment, a display control is performed, for example, by allowing the CPU 101 to execute a program recorded, for example, in the system memory 103 and the HDD 109.

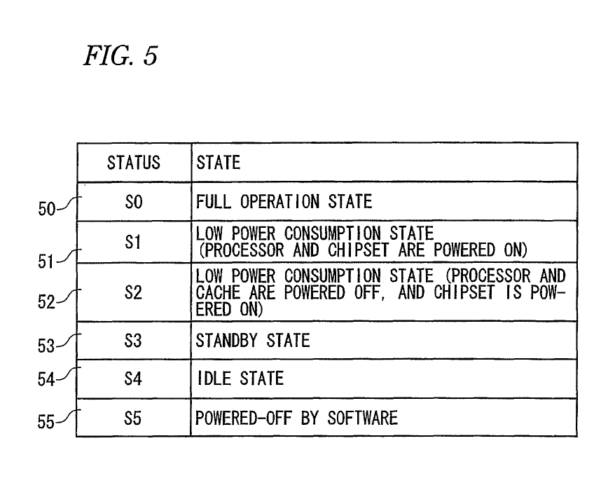

FIG. 5 is a diagram to describe a regulation in a power saving standard used in the electronic apparatus 10 according to the embodiment.

In the case of temporarily halting the use of the PC 10, it is possible to suppress power consumption by switching the PC 10 to a standby state (suspend) or an idle state (hibernation).

In particular, in the case of an electronic apparatus (e.g., notebook type PC) being driven by, for example, a battery, it is possible to relatively quickly suspend and resume a work while suppressing the power consumption by setting the electronic apparatus to a standby state during moving. Also, even in the case of, for example, a desktop PC, it is possible to suppress the power consumption by setting the desktop PC to be in the standby state or the idle state while the desktop PC is not being used.

However, in “Advanced Configuration and Power Interface (ACPI)”, an electric power circumstance (sleep state (status) of power saving standard) in a power saving system of the electronic apparatus (PC) is specified as six steps from “S0 (full operation)” to “S5 (powered off by software)”.

FIG. 5 describes the status of “ACPI” power saving standard.

Reference numeral 50 indicates that the status of the electronic apparatus (PC) is “S0”, specifying a “full operation state” in which the electric power is supplied to the entire electronic apparatus (PC).

Reference numeral 51 indicates that the status of the electronic apparatus (PC) is “S1”, specifying a “low power consumption state”. In the “S1” state, a processor and a chip set are powered ON.

Reference numeral 52 indicates that the status of the electronic apparatus (PC) is “S2”, specifying a “low power consumption state”. In the “S2” state, the processor and a cache are powered OFF, and the chip set is powered ON.

Reference numeral 53 indicates that the status of the electronic apparatus (PC) is “S3”, specifying a “standby state”.

Reference numeral 54 indicates that the status of the electronic apparatus (PC) is “S4”, specifying an “idle state”.

Reference numeral 55 indicates that the status of the electronic apparatus (PC) is “S5”, specifying a “powered-OFF by software”.

The “standby state” and the “idle state” are now described.

The “standby state” is a mode for suppressing the power consumption by turning OFF the graphic function, a hard disk, or other device.

In the standby state, the power is supplied to the system memory 103, and data being executed is maintained. Thus, a resume process can be executed when the work is temporary suspended unlike the powered ON/OFF state. It generally takes a few seconds to return from the “standby state”.

The “idle state” is a mode for turning OFF each device including the system memory 103 after storing the content of the system memory 103 into the hard disk 110. As a result, a data storage area for the “idle state” having the nearly same capacity as the system memory 103 is secured in the hard disk 110.

In the “idle state”, for example, the power of the battery is not consumed even in a driving of the notebook PC by the battery. Therefore, it is possible to continuously maintain the “idle state”. However, since the content of the system memory 103 needs to be stored in or read-out from the hard disk 110, it takes time to switch to the “idle state” or return from the “idle state”, compared to the “standby state”.

The embodiment relates to a technology in which the electronic apparatus returns to an active state from the “standby state (S3)”.

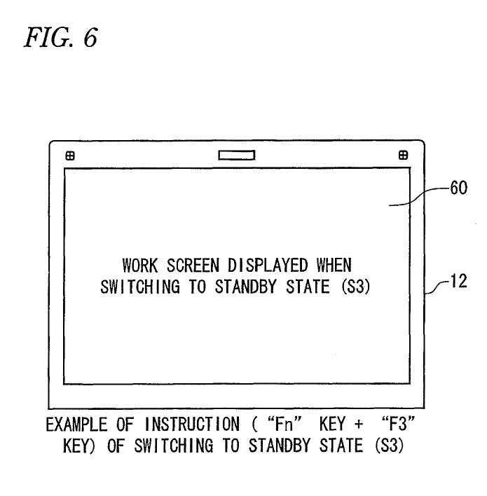

FIG. 6 is a diagram illustrating a work screen displayed when switching to the standby state (S3) in the electronic apparatus 10 according to the embodiment.

Here, for example, a user instructs switching to the standby state (S3) by manipulating the keyboard 13 (e.g., “Fn” key+“F3” key) of the PC 10.

Reference numeral 60 represents a work screen display displayed on the image display module 12. Here, an expression “work screen displayed when switching to “standby state (S3)” is being displayed.

In the present embodiment, according to the instruction to switch to the standby state, the work screen display 60 (display information of a work screen displayed on the image display module) is stored and is maintained in the SSB 22.

A resume instruction is received in the standby state of the electronic apparatus (PC) 10. According to the resume instruction, the display information is displayed on the image display module 12 using the display information of the work screen that is stored in the storage module (SSB) 22.

As configured above, in the embodiment, it is possible to decrease the time, for example, of about 2 to 3 seconds, required for the resume processing (switching to the standby state (S3)) to, for example, about 0.3 seconds by switching to the standby state (S3) using, for example, the aforementioned SSB 22.

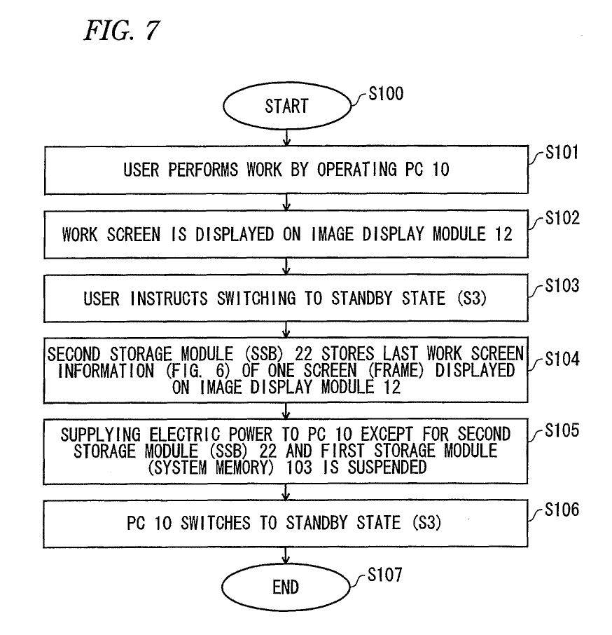

FIG. 7 is a flowchart illustrating a process of storing display information of a work screen that is displayed on the image display module according to an instruction to switch to the standby state in the electronic apparatus 10 according to the embodiment

Step S100 is herein a start step, and then the process proceeds to step S101.

At step S101, a user performs a work by operating the PC 10, and then the process proceeds to step S102.

At step S102, a work screen is displayed on the image display module 12 of the PC 10, and then the process proceeds to step S103.

At step S103, the user instructs switching to the standby state (S3) by operating, for example, the keyboard 13 of the PC 10 as described above, and then the process proceeds to step S104.

At step S104, the second storage module (SSB) 22 stores, for example, last work screen information (of, for example, FIG. 6) of at least one screen (frame) that is displayed on the image display module 12 when the instruction to switch to the standby state S3 is received, and then the process proceeds to step S105.

At step S105, supplying the electric power to the PC 10 except for the second storage module (SSB) 22 and the first storage module (system memory) 103 is suspended, and then the process proceeds to step S106.

At step S106, the PC 10 switches to the standby state (S3), and then the process proceeds to step S107.

Step S107 is an end step, and the process is terminated.

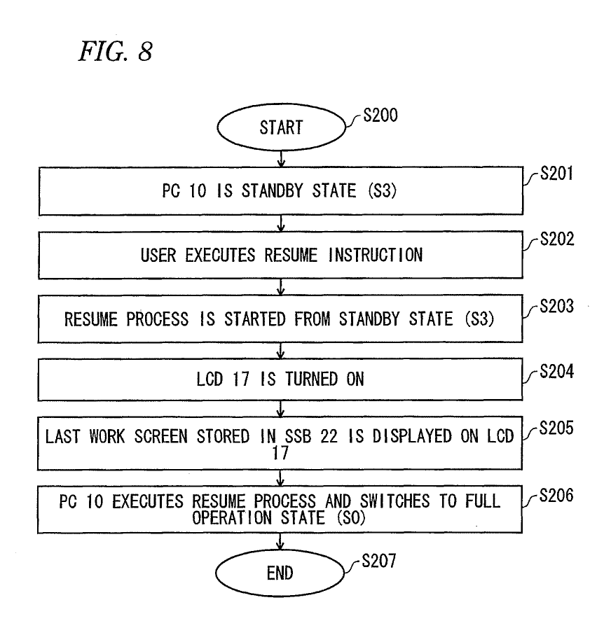

FIG. 8 is a flowchart illustrating the process of displaying using stored display information of work screen according to a resume instruction received in the standby state, in the electronic apparatus 10 according to the embodiment.

Step S200 is herein a start step, and then the process proceeds to step S201.

At step S201, the PC 10 is switching to the standby state (S3), and then the process proceeds to step S202.

At step S202, the user executes a “resume” instruction by operating, for example, the keyboard 13 of the PC 10.

Here, “resume” is described.

“Resume” indicates an operational function by which a computer (PC) returns to an original state by supplying power to the computer (PC) remained in a suspend state. “Resume” may be used as the same meaning as a suspend function.

Next, the process proceeds to step S203.

At step S203, a resume process is started from the standby state (S3), and then the process proceeds to step S204.

At step S204, the LCD 17 of the image display module 12 is turned ON. Turning ON/OFF of the LCD 17 is controlled by, for example, the timing controller (TCON) 21 that is controlled by the GPU 105, and then the process proceeds to step S205.

At step S205, the last work screen stored in the SSB 22 is displayed on the LCD 17, and then the process proceeds to step S206.

At step S206, the PC 10 executes the resume process and the PC 10 switches to the full operation state (S0), and then the process proceeds to step S207.

Step S207 is an end step, and the process is terminated.

In the embodiment as described above, it is possible to decrease the time required until the electronic apparatus 10 returns to an active state after completing the resume process.

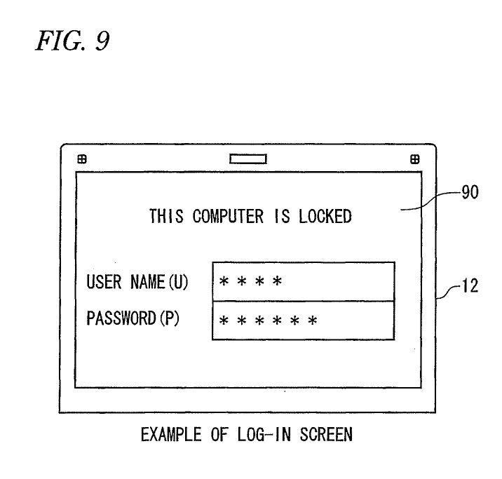

FIG. 9 is a view illustrating a log-in screen displayed in the electronic apparatus 10 according to the embodiment.

Similarly to the above, for example, the user instructs switching to the standby state (S3) by operating the keyboard 13 (e.g., “Fn” key+“F3” key) of the PC 10.

Reference numeral 90 represents an example of a “log-in screen” for prompting a user to input predetermined information such as a user name, a password when returning from a standby state.

In the embodiment, according to the instruction to switch to the standby state, display information such as the user information (e.g., the user name and the password) used for displaying the work screen using the electronic apparatus (PC) 10 at the time of the instruction is stored and maintained in the SSB 22.

When the electronic apparatus (PC) 10 receives the resume instruction in the standby state, the PC 10 displays the “log-in screen” 90 stored in the SSB 22 on the image display module 12 according to the resume instruction.

For example, when a predetermined display information such as the user name and the password is inputted by the user, the inputted user information is collated with the user information (e.g., user name and password) maintained in the SSB 22.

Here, when the collated information matches with each other, the log-in process is performed and the PC 10 returns from the standby state. When the collating does not match, the log-in process is not performed.

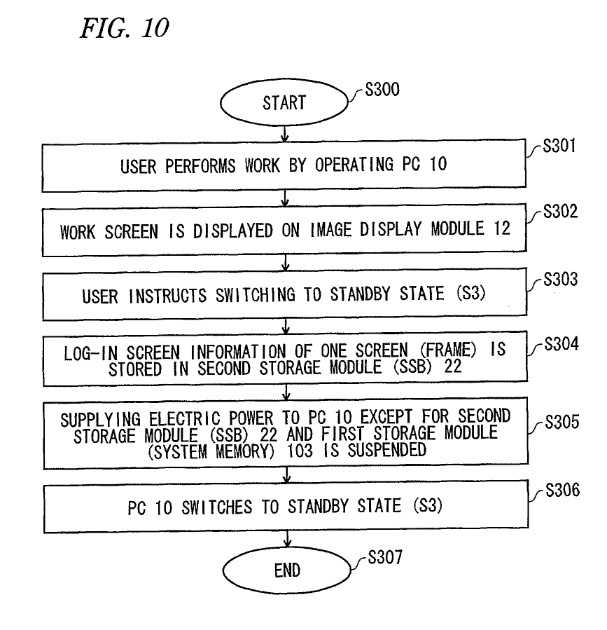

FIG. 10 is a flowchart illustrating a process of storing display information of a log-in screen according to an instruction to switch to a standby state, in the electronic apparatus 10 according to the embodiment

Step S300 is herein a start step, and then the process proceeds to step S301.

At step S301, for example, the user performs a work by operating the PC 10, and then the process proceeds to step S302.

At step S302, a work screen is displayed on the image display module 12, and then the process proceeds to step S303.

At step S303, as described above, the user instructs switching to the standby state S3 by operating, for example, the keyboard 13, and then the process proceeds to step S304.

At step S304, log-in screen information of one screen (frame) is stored in the second storage module (SSB) 22, and then the process proceeds to step S305.

At step S305, supplying the electric power to the PC 10 except for the second storage module (SSB) 22 and the first storage module (system memory) 103 is suspended, and then the process proceeds to step S306.

At step S306, the PC 10 switches to the standby state (S3), and then the process proceeds to step S307.

Step S307 is an end step, and the process is terminated.

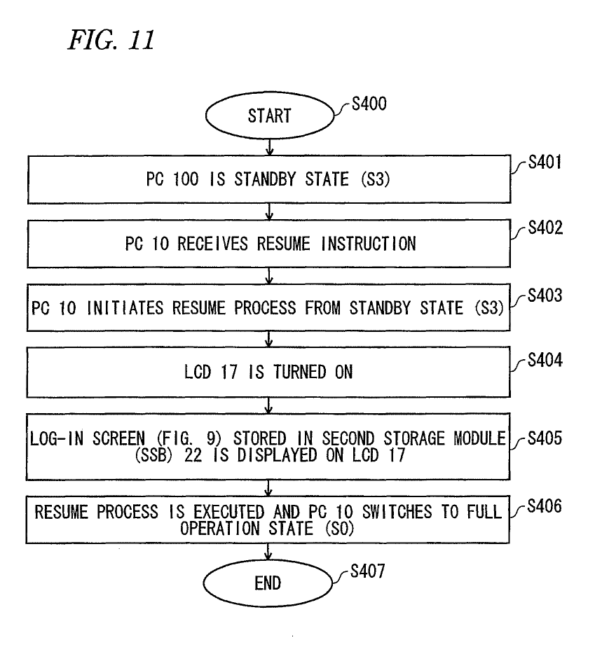

FIG. 11 is a flowchart to describe a process of performing a display using stored display information of a work screen according to a resume instruction received in a standby state, in the electronic apparatus 10 according to the embodiment.

Step S400 is herein a start step, and then the process proceeds to step S401.

At step S401, the PC 100 switches to the standby state (S3), and then the process proceeds to step S402.

At step S402, the PC 10 receives a resume instruction and then the process proceeds to step S403.

At step S403, the PC 10 initiates a resume process from the standby state (S3), and then the process proceeds to step S404.

At step S404, the LCD 17 of the image display module 12 is turned ON, and then the process proceeds to step S405.

At step S405, the log-in screen (for example, FIG. 9) stored in the second storage module (SSB) 22 is displayed on the LCD 17, and then the process proceeds to step S406.

At step S406, when the collated display information (user information) matches with each other, the instructed resume process is executed and the PC 10 switches to the full operation state (S0), and then the process proceeds to step S407.

Step S407 is an end step, and the process is terminated.

As described above, in the embodiment, it is possible to decrease the time required until the electronic apparatus 10 returns to an active state after completing the resume process. In the embodiment, since a log-in screen is displayed and the resume process is executed when the collated display information (user information) matches with each other, it is possible to improve the privacy feature in addition to the aforementioned features.

The entire control processing of the embodiment may be performed by software. Thus, it is possible to readily achieve the same effect as the above embodiment only by installing a program for executing the control processing in a general purpose computer through a computer-readable recording medium storing the program, and executing the installed program.

While certain exemplary embodiment has been described, the exemplary embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a storage module configured to store display information of a work screen that is displayed on an image display module according to an instruction to switch to a standby state;
a power supply module configured to receive a resume instruction in the standby state, and to supply power to the image display module according to the resume instruction; and
a work screen display module configured to display an image on the power-supplied image display module using display information of the work screen stored in the storage module.

2. The apparatus of claim 1, wherein the storage module is substantially provided in the image display module.

3. The apparatus of claim 1, wherein the storage module is connected to a backup power source capable of supplying power in the standby state.

4. The apparatus of claim 1, wherein power is supplied to the storage module in the standby state.

5. The apparatus of claim 1, wherein the power supply module is substantially provided in the image display module.

6. The apparatus of claim 1, wherein the display information of the work screen is display information of a last work screen that is displayed when switching to the standby state.

7. The apparatus of claim 1, wherein the storage module is configured to store log-in screen information according to the instruction to switch to the standby state instead of the display information of the work screen, and the image display module is configured to display the display information using the log-in screen information stored in the storage module.

8. The apparatus of claim 1, wherein the storage module includes a static screen buffer.

9. A control method of an electronic apparatus, comprising:
storing display information of a work screen that is displayed on an image display module according to an instruction to switch to a standby state;
receiving a resume instruction in the standby state, and supplying power to the image display module according to the resume instruction; and
displaying an image on the power-supplied image display module using the display information of the stored work screen.

10. A non-transitory computer-readable medium storing a computer executable control program of an electronic apparatus that, when executed causes a computer to perform a control method comprising:
storing display information of a work screen that is displayed on an image display module according to an instruction to switch to a standby state;
receiving a resume instruction in the standby state, and supplying power to the image display module according to the resume instruction; and
displaying an image on the power-supplied image display module using the display information of the stored work screen.
